(19) United States
(12) Patent Application Publication
(10) Pub. No.: US 2008/0114630 A1
(43) Pub. Date: May 15, 2008

(54) Aerospace and defense program analysis tool

(75) Inventors: David J. Chang, Troy, MI (US); Robert S. Forrest, Washington, DC (US); Katherine R. Sherwood, San Francisco, CA (US)

Correspondence Address: ACCENTURE, LLP;C/O HOGAN & HARTSON, LLP (IPGROUP), 555 13TH STREET NW, SUITE 600E, WASHINGTON, DC, 20004, US

(73) Assignee: Accenture Global Services GmbH

(21) Appl. No.: 11/599,589

(22) Filed: Nov. 15, 2006

(51) Int. Cl. G06F 9/44

(52) U.S. Cl. 705/7

(57) ABSTRACT

The invention provides automatically examines an Aerospace and Defense (A&D) company's financial data and evaluating factors affecting the company's value, and using this evaluation to assess the desirability of proposed changes in various stages of an A&D project. Specifically, the present invention evaluates changes in an A&D company's value through that company's profits and capital efficiency. The Program Profitability asset is a methodology and tool that helps teams quickly and systematically analyze high impact areas in the structure of a program to determine the key drivers of savings that are actionable for the client.

### BACKGROUND OF THE INVENTION

1. Field of the Invention

The present invention relates to computerized system and method that automatically evaluates proposed changes in the operation of an Aerospace And Defense (A&D) company during a project. More specifically, the present invention analyzes an A&D organization's financial data to identify various factors that influence that organization's financial performance value, and uses these financial factors to recommend changes and/or to evaluate the proposed changes according to the predicted changes to these financial factors.

2. Background of the Invention

In the United States, high fixed costs, fewer full production projects and intense competition have eroded Aerospace and Defense (A&D) company profits. Specifically, the industry has seen profitability erosion due to high fixed-cost structures and over capacity, rising percentage of developmental versus full production projects, and increasing competition for commercial and defense contracts. As shown in Table 100 of FIG. 1, the profitability levels in various A&D fields have consistently dropped throughout the recent past.

Aerospace & Defense companies are facing increasing intense demands from their government customers to leverage commercial leading practices to reduce the per unit cost to the government.

Aerospace & Defense companies operate in a unique environment. Accurately assessing program profitability depends heavily on where the Program is in its lifecycle, and thus there is a current need for a tool that uses a lifecycle-based approach to assess profitability.

Moreover, there is a current need for an evaluation framework and quantitative analysis examples for Aerospace and Defense Industry client program profitability, both for opportunities and risks at any stage in a Program lifecycle, for both prime contractors and subcontractors.

### SUMMARY OF THE INVENTION

In response to these and other needs, the present invention provides a system and related method for automatically examining an A&D company's financial data and evaluating factors affecting the company's value, and using this evaluation to assess the desirability of proposed changes in various stages of an A&D project.

Specifically, the present invention evaluates changes in an A&D company's value through that company's profits and capital efficiency. In a preferred embodiment, the present invention further evaluates the financial data of other companies, such as competitors, and compares the various factors affecting value.

The Aerospace and Defense Program Profitability Business Method provided in the present invention is intended to address significant shifts in the industry, centered on changes in customer expectations, competition, contracting models, and complexity. Implications for profitability in the industry include competitive advantages shifting to primary parties who are able to operate more profitably and increasingly provide services, greater emphasis being placed on reducing total cost of ownership over a program's entire lifecycle, increased risk, accountability and incentives are under increasingly stringent contracting models while maintaining profitability, improved revenue stability and returns to suppliers who successfully win and deliver against new customer requirements, and an increasing ability to leverage a global supply base.

The Aerospace and Defense Program Profitability Business Method is a rapid diagnostic tool developed to support the identification and prioritization of key profit improvement opportunities and the development of an implementation roadmap.

The Program Profitability asset is a methodology and tool that helps teams quickly and systematically analyze high impact areas in the structure of a program to determine the key drivers of savings that are actionable for the client.

Key elements of the asset are (a) rigorous methodology and (b) rapid execution. The Solution is specifically tailored to the Aerospace and Defense industry and specifically targets industry programs, incorporating:
Industry Lifecycle Framework
Industry Value Tree
“As-Is” State of the Program Assessment Questions and Standards
Program Specific Assessment Questions
Data Analysis Template

In another embodiment, the present invention includes a system for predicted changes in value caused by a proposed A&D project change. In one embodiment, the system is a software-based application that collects or receives financial data and uses this information to calculate the changes in the company's value. In a particular implementation, the system is connected to a distributed network such as the Internet to automatically receive data and to use this data in calculating the return to investors. At times, an A&D company's return is known and various unknown accounting values may be deduced using various calculations used to calculate A&D company's value.

In other embodiments, the present invention provides a system where publicly available data is collected and combined with private data at a local data storage device. The locally stored data may then be manipulated as needed to perform desired A&D company's value calculation and measurements.

In particular, the locally stored data may be manipulated to reflect A&D project changes and to predict the impact to A&D company's value from these changes. In this way, the present invention may be used to evaluate the relative importance of these accounting values in the calculation of A&D company's return and the ability of A&D project change to change these values. For example, the present invention may calculate the sensitivity of an A&D company's return to various changes to (e.g., the adjusting a measure by plus or minus a predefined constant value). The sensitivity of the A&D company's return to the various measurements or levers provides important insight into an organization's performance and needs. Where an A&D company's return is particularly sensitive to changes in a specific lever, this suggests that the organization is underperforming in areas related to that measure value, and that A&D project changes for improving these areas would be generally desirable.

In a similar way, the sensitivity analysis may be repeated for several organizations, and the performance of the organizations may compared according to the relative sensitivities of these organization's A&D company's return to changes in a shared accounting value.

### BRIEF DESCRIPTION OF THE DRAWINGS

A more complete understanding of the present invention and advantages thereof may be acquired by referring to the following description taken in conjunction with the accompanying drawings in which like reference numbers indicate like features, and wherein:

FIG. 1 is a table depicting aspects of the A&D industry;

FIGS. 2A-2B is a screen shot depicting aspects of the A&D program analysis tool in accordance with embodiments of the present invention;

FIG. 3 depicts a value tree employed in embodiments of the present invention;

FIGS. 4-5 and 12 schematically depicts the steps of the A&D program analysis method in accordance with embodiments of the present invention;

FIGS. 6-9 depict possible output results produced during the A&D program analysis method depicted in FIGS. 4-5 and 12 in accordance with embodiments of the present invention;

FIGS. 10-11 schematically depicts the parts of the A&D program analysis tool for implementing the A&D program analysis method depicted in FIGS. 4-5 and 12 in accordance with embodiments of the present invention.

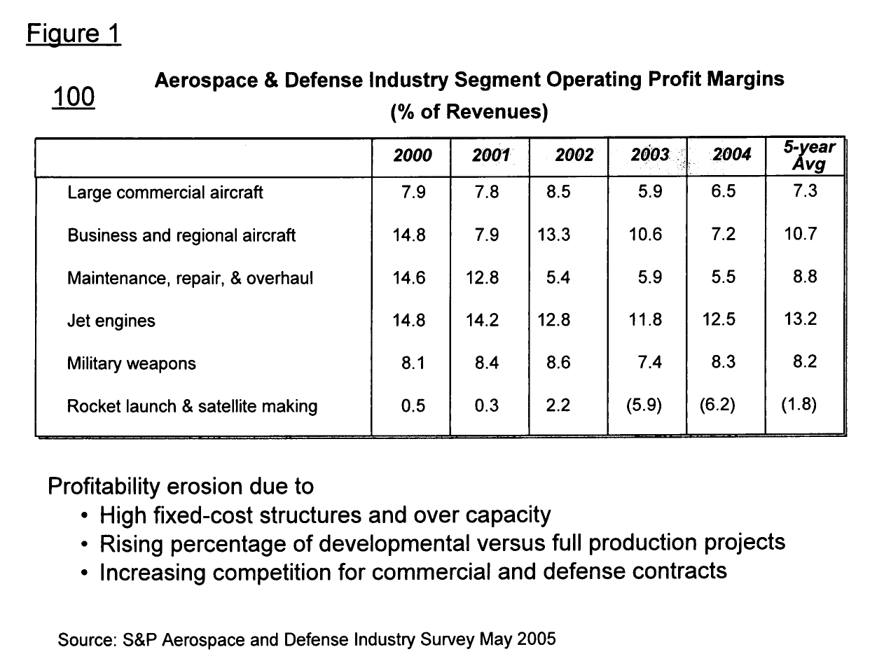

### DETAILED DESCRIPTION OF THE PREFERRED EMBODIMENTS

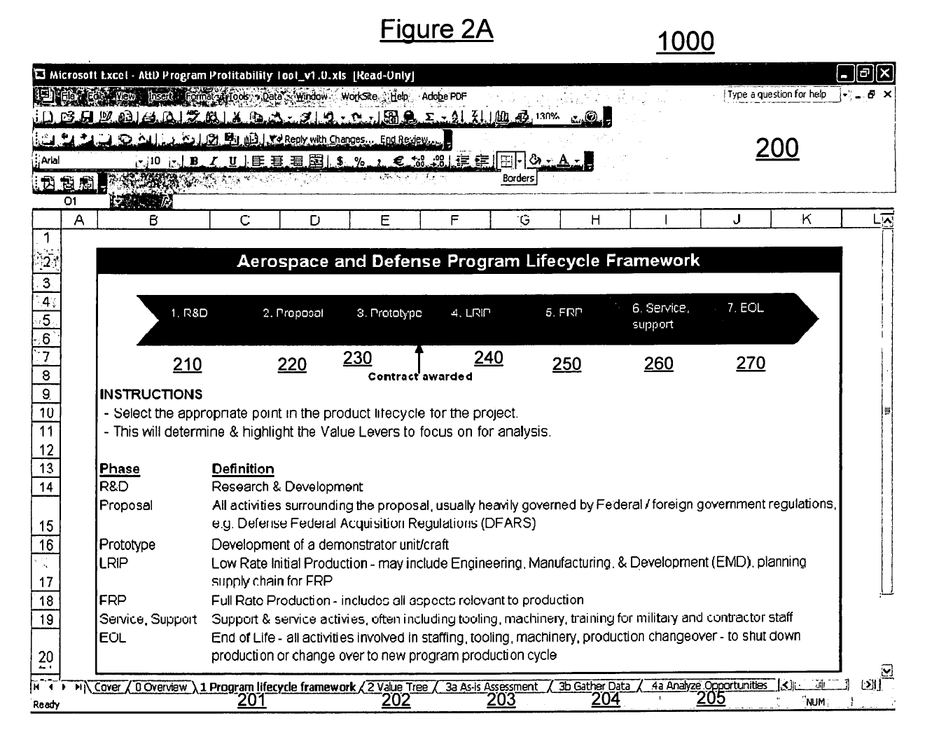

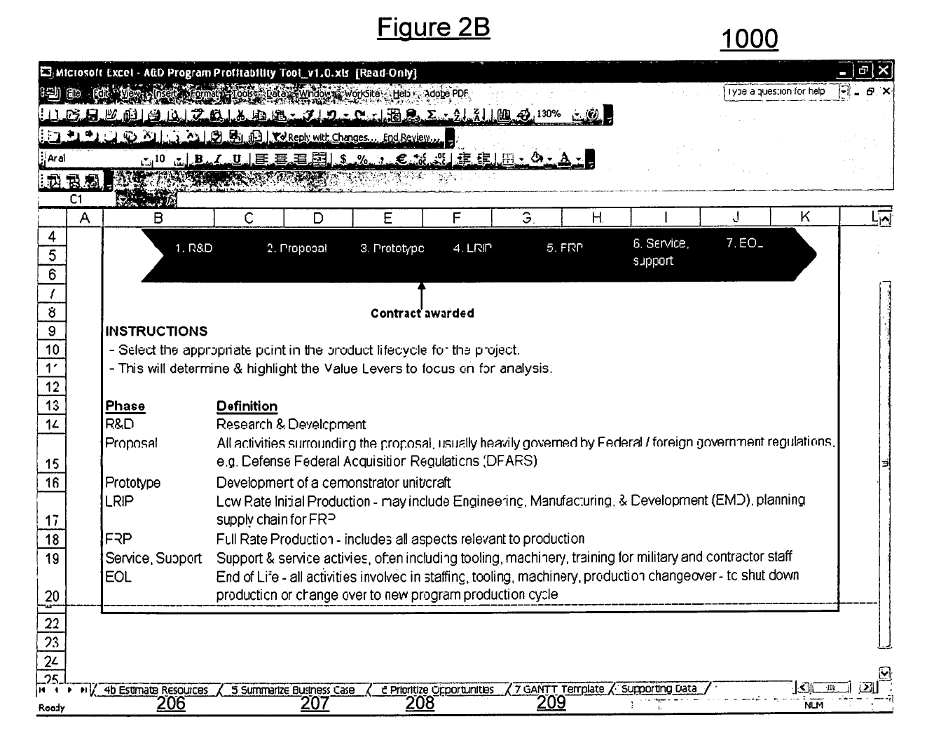

A typical product life cycle in the A&D industry is now introduced so that these concepts can be referenced through this discussion. An Aerospace and Defense Program Lifecycle Framework 200 is depicted in FIG. 2A. In the R&D phase 210, the A&D company performs Research & Development. In Proposal phase 220, the A&D company performs all activities surrounding the proposal, usually heavily governed by Federal/foreign government regulations, e.g. Defense Federal Acquisition Regulations (DFARS). In prototype phase 230, the A&D company performs development of a demonstrator unit/craft. If the A&D company is awarded the contract following the prototype phase 230, in Low Rate Initial Production (LRIP) phase 240, the A&D company performs LRIP, and this LRIP may include Engineering, Manufacturing, & Development (EMD), and planning supply chain for Full Rate Production (FRP). In FRP phase 250, the A&D company performs, and this process includes all aspects relevant to actual production. In support and service phase 260, the A&D company performs support and service activities, often including tooling, machinery, training for military and contractor staff. In End-of-Life (EOL) phase 270, the A&D company performs various EOL functions such as activities involved in staffing, tooling, machinery, production changeover to shut down production or change over to new program production cycle.

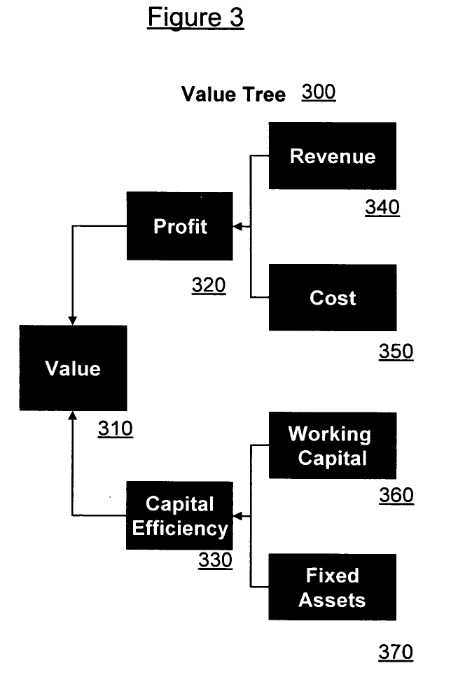

Referring now to FIG. 3, the A&D program analysis methodologies of present invention employ a value tree 300 to support the creation of value 310 and generally require focusing on the opportunities that have the largest impact on reducing costs or increasing revenues. Specifically, the methods of the present invention generally address creation of value 310 through evaluation of effects on profits 320 and capital efficiency 350. More specifically, profits 320 derived from daily business operations and are measured as the difference between revenue 330 and costs 340. Capital efficiency 350 reflects gains from the A&D company from correct management of its working capital 360 and its fixed assets 370

Revenue accounting generally includes aspects from sales volume, prices, and the particular mix of sold products and services. It should also be appreciated that revenues are often difficult to control in the A&D field due to its nature. For example, A&D businesses often have limited markets (such as governments) and operate under long-term fixed prices due to binding contracts terms.

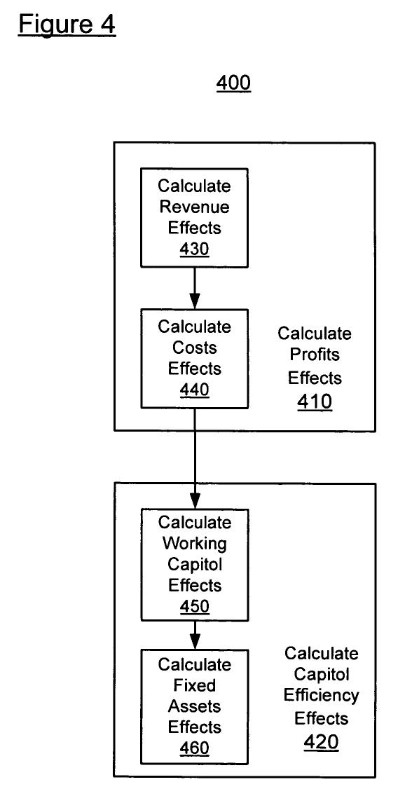

Turning now to FIG. 4, embodiments of the present invention provide a value calculation method 400 corresponding to the value tree 300 for automatically evaluating various factors contributing to an A&D company's value 310. Value creation determined is computed using profits and capital efficiency, as determined in steps 410 and 420, respectively. The steps in the value calculation method 400 are described in greater detail below.

The various calculations in the value calculation method 400 may look to information in an A&D company's financial statement. Financial statements generally items such as a balance sheet, income statement, cash flow statement, and notes to the financial statements. Core Financial Statements contents include: Balance Sheet; Income Statement; Cash Flow Statement; and Notes to the Financial Statements.

A Balance Sheet is a snapshot at one point in time in the life of a business. The balance sheet represents the financial state of the company at that point in time. The left side of the financial state represents the company's various assets, including:
a. Current Assets such as Cash, Short-term investments (debt and equity securities), Accounts receivable, Inventory, and Prepaid accounts;
b. Long-term Investments including debt and equity securities, and Investments in non-consolidated subsidiaries;
c. Property, Plant & Equipment such as Land, Machinery & Equipment, Furniture & Fixtures, and Accumulated depreciation; and
d. Intangibles assets such as Patents, Goodwill, Franchises, and Trademarks.

### Conversely, the right side of the financial state represents the company's various liabilities, including

e. Current Liabilities such as Accounts payable, Deferred revenues, Current-portion of long-term debt, and Income taxes payable;
f. Long-term Liabilities including Pension liabilities, Bonds payable, Notes payable, Deferred tax liability; and
g. A&D company's Equity including Common stock (at par), Additional paid-in capital, Preferred stock, and Retained earnings.

Continuing with the financial statement, it generally includes an income statement that shows the income generated and the costs incurred over a period of time, such as a financial year. Aspects of the income statement include:
a. Cash and credit sales;
b. the Cost of Goods Sold including costs for raw materials, Direct labor, Factory overhead (including production depreciation), and Freight-in;
c. Selling, General, and Administrative costs such as Non-production salaries (marketing, sales, accounting, etc.), and Amortization;
d. Miscellaneous costs such as freight-out, Advertising/marketing expenses, and Non-production depreciation;
e. Non-operating expenses including Income/Expense and Gain/loss associated with sale of assets other than inventory Gains/losses associated with non-operating activities;
f. Interest Expenses such as Interest on debt payable and Interest on capital lease obligations; and
g. Income Tax Expense including deferred tax expense and Income tax expense.

Another aspect of the company's financial statement is a Cashflow Statement that is simply a statement of all the cash received or paid during the year. The Cashflow Statement includes various data including:
a. Changes in Cash and Cash Equivalents for the Period describing Cash Flows from Operating Activities, Investing Activities, and Financing Activities adjusted for Cash Outflows;
b. Net cash provided by operating activities such as Net income, Depreciation and amortization, Deferred income taxes, Equity income or loss, net of dividends, Foreign currency adjustments, Gains on sales of assets, and Net change in operating assets and liabilities;
c. Net cash used in investing activities such as Acquisitions and investments, purchases of investments and other assets, proceeds from disposals of investments and other assets, Purchases of property, plant and equipment, and Proceeds from disposals of property, plant and equipment;
d. Financing Activities such as Issuances of debt, Payments of debt, Issuances of stock, Purchases of stock for treasury, and Dividends;
e. The Effect of Exchange Rate Changes on Cash and Cash Equivalents; and
f. Cash and Cash Equivalents Balance at end of year, specifically, Net increase (decrease) during the year, and Balance at beginning of the year.

Another integral part of the company's financial statement is a section of Notes to the Accounts where all the small print is found. The Notes to the Accounts contain valuable information on the following:
Accounting conventions used;
Fair value of assets (marketable securities, fixed assets, equity investments, intangible assets);
Details of liabilities (type and term of debt);
Segment data (geographic, product, divisional);
Details of shares and new issuance;
Details of pension liabilities;
Details of Employee Stock Option Plans (ESOP's); and
Off-balance sheet liabilities (leases, derivatives).

Returning now to FIG. 4, the value calculation method 400 includes the steps of calculating changes in profits in step 410 and the calculation of changes to capital efficiency in step 420. The calculation of changes in profits in step 410 addresses value through the business operations of the A&D company whereas the calculation of capital efficiency in step 420 addresses changes in the value of the company through changes in the company's structure and management. The calculation of changes in profits in step 410 may include evaluation of revenue in step 430 and costs in step 440. Similarly, the calculation of effects from changes in capitol efficiency in step 420 includes evaluation of working capitol effects 360 and fixed assets effects 370.

### Profits

The determination of profits in step 410 generally includes the calculation of a net operating profit less adjusted taxes (NOPLAT). NOPLAT is the total operating profits for a business with adjustments made for taxes. Thus, NOPLAT measures the total cash available for distribution to financial capital contributors.

NOPLAT may be determined in two ways, either adjusting from revenues (“top down”) or adding back to net income (“bottom up”). Either method may be used and both may be done to ensure that the calculations of NOPLAT are performed correctly. Thus, in the top down method,

$$NOPLAT = Reported EBITA - Taxes on EBITA + Increase in Deferred Taxes \qquad ( Eq . 1 )$$

where the EBITA (Earnings Before Interest, Taxes, and Amortization) is typically calculated by looking to the company's revenue 330 (i.e., sales collections equal to sales volume time sales price), adjusted for costs 340 such as the Cost of goods sold (COGS) including such as wages and material costs associated with producing the good/service and any depression; selling, general and administration expenses (SG&A) including other wages, commissions, and fees; depreciation expense; and other operating expenses. In the top down method, a company's Net Income is summed with any increases in deferred taxes, goodwill amortization, any extraordinary accounting items (also called special items after taxes or after tax items), and minority interest income to calculate an Adjusted Net Income for that company. Then, the Adjusted Net Income is summed with any interest expenses after tax to determine the company's Total Income Available to Investors. NOPLAT may then be calculated by subtracting Interest income after-tax and Non-operating income after-tax from the Total Income Available to Investors.

It should be appreciated that Profits 320, or NOPLAT, can be disaggregated into smaller components that provide more insight into the performance of the asset under review. This disaggregation process can continue to levels with more and more actionable components, as described in greater detail below.

### Profit Levers

Various exemplary value levers applicable to volume aspects of revenue 330 in an A&D project are depicted below in Table 1:

TABLE 1

| Value Levers | Definitions | Potential Measurements |
|---|---|---|
| Rate of | Speed at which | number of New program |
| innovation | company brings | announcements (vs. |
| | new products to | competitors) |
| | market. | |
| Time to market | Time from initial | number of Months |
| | concept to | between concept |
| | proposal | announcement & proposal |
| | | at DoD (or other |
| | | government) |
| Re-use of IP | Ability for | number of Program |
| | company to | extensions (similar to |
| | repurpose | “Line extensions” or |
| | innovations from | “Brand extensions” in |
| | one client, | non-Defense industries) |
| | program, or | |
| | effort to others | |
| New customers and | Concentration of | number of New customers |
| markets (e.g., | customers | or programs in past 1 |
| foreign military | | year, 5 years, 10 |
| sales) | | years. number of new |
| | | “non-traditional” |
| | | customers, e.g. Eastern |
| | | hemisphere governments |

### It should be appreciated that various other Volume-related profits levers may be used as needed and incorporated.

Various exemplary value levers applicable to price aspects of revenue 330 are listed below in Table 2:

TABLE 2

| Value Levers | Definitions | Potential Measurements |
|---|---|---|
| Multi-year buys | Clients | percentage of Partners |
| | purchasing | & End customers using |
| | products with | multi-year buys today; |
| | multi-year | change in this over |
| | contracts and | time. |
| | potential | |
| | extensions to | |
| | current contracts | |
| Offsets (deals | Requirements by | number offsets used. |
| for in-country | government | percentage of Program |
| production) | customers (e.g. | spent on Offset |
| | DoD, Foreign | suppliers (required or |
| | Military) that | otherwise). |
| | some portion of | |
| | Program spend be | |
| | to buy from in- | |
| | country, in- | |
| | state, or other | |
| | restricted | |
| | suppliers (e.g. | |
| | Minority/Women- | |
| | owned businesses) | |
| Discount strategy | Strategy used, | Formal discount |
| | with end-customer | strategy in place, with |
| | (Government) | pricing bands and |
| | and/or next | levels of approval |
| | channel customer, | authority to go outside |
| | to avoid | pricing bands. |
| | discounting away | |
| | all profit | |
| | potential | |

### It should be also appreciated that various other price-related revenue levers may be used as needed and incorporated into the present invention.

Various exemplary value levers applicable to sale/service product aspects of revenue 330 are listed below in Table 3:

TABLE 3

| Value Levers | Definitions | Potential Measurements |
|---|---|---|
| Product (Program) | Framework and | Profits |
| strategy | activities to | |
| | keep individual | |
| | products | |
| | (Programs) | |
| | profitable | |
| Service strategy | Framework and | Profits |
| | activities to | |
| | provide service | |
| | and support for | |
| | products sold. | |
| Portfolio management | Framework and | Profits |
| strategy | activities to | |
| | consider the | |
| | entire portfolio | |
| | of multiple | |
| | Programs within | |
| | a client. | |
| After-sales support | Level of support | percentage of on-site |
| (Maintenance, Repair | provided | or field support |
| and Operations - MRO, | directly by | provided directly by |
| Field level/Depot level | client or as | client, profitability |
| service) | contract to | of on-site or field |
| | client | support |
| Total Cost of | Readiness & | Sigma quality |
| Ownership, or TCO, | sustainment: | |
| (readiness and | total cost of | |
| sustainment/contracting | providing. | |
| for availability) | Contracting for | |
| | Availability - | |
| | taking the | |
| | operational risk | |
| | with the end- | |
| | user that the | |
| | component will | |
| | be (for example) | |
| | 3-sigma quality | |
| | 99.9 percentage | |
| | of available). | |

### It should be also appreciated that various other revenue-related product-mix levers may be used as needed and incorporated into the present invention.

Often, value creation analysis more focuses on a reduction of costs 340 because the A&D businesses typically have more control over costs than revenues, as described above. Aspects of cost 340 include:
Selling expenses—making RFP/RFQ, contracting approaches
Design Cost—customization, configuration-change-part mgmt
Sourcing Cost—direct material, vendor mgmt, non-recurring
Make—variable labor, consumables, quality
Delivery Cost—transportation, installation, test and acceptance
Service—warranty, parts, service tracking, MRO, modifications
Support/Sustainment—parts, deployed support, capability updates
Administrative—support functions, employee services, overhead
Risk management

Various exemplary value levers applicable to Selling & Proposal aspects of costs 340 are listed below in Table 4:

TABLE 4

| Value Levers | Definitions |
|---|---|
| Win strategy - | Framework and |
| prototypes | activities to |
| | create prototypes |
| | that win business |
| | at the lowest |
| | possible |
| | investment |
| Win strategy - BD | Framework and |
| sales | activities to win |
| | new Program |
| | contracts from |
| | government |
| | customers. |
| Post-win | Framework and |
| mobilization | activities to |
| | launch new |
| | Program upon |
| | winning |
| | government |
| | contract |

Various exemplary value levers applicable to administrative aspects of costs 340 are listed below in Table 5:

TABLE 5

| | | Potential |
|---|---|---|
| Value Levers | Definitions | Measurements |
| Outsourcing: IT, HR, | Cost and service | Profits |
| and Finance | level | |
| | requirements of | |
| | pure-support | |
| | functions | |
| | including but | |
| | not limited to | |
| | IT, HR, Finance | |
| | support | |
| ERP solutions | ERP | Profits |
| | implementation | |
| | currently in | |
| | place | |
| Risk Management | Type and amount | Profits |
| solutions | of risk | |
| | management | |
| | solutions | |
| | currently in | |
| | place | |
| EOL cost avoidance - | Framework and | percentage of on-site |
| managing aging | activities to | or field support |
| workforce | manage issues of | provided directly by |
| | aging workforce | client, profitability |
| | | of on-site or field |
| | | support |
| EOL cost avoidance - | Framework and | Sigma quality |
| labor union | activities to | |
| optimization | manage labor | |
| | unions | |

Various exemplary value levers applicable to research and Development (R&D) aspects of costs 340 are listed below in Table 6:

TABLE 6

| Value Levers | Definitions | Potential Measurements |
|---|---|---|
| Engineering change cost | Cost of | number of convenience |
| reduction | “Convenience” or | change orders; as |
| | “Class 2” | percentage of total |
| | engineering | change orders; cost |
| | change orders | per change order for |
| | | convenience change |
| | | orders vs. required |
| | | change orders; number |
| | | and percentage of |
| | | suppliers impacted; |
| | | number and percentage |
| | | of processes impacted |
| Reduce engineering | Number and cost | number of required |
| errors | of engineering | engineering change |
| | errors that | orders; as percentage |
| | require remedy | of total change |
| | | orders; cost per |
| | | change order for |
| | | required change orders |
| | | vs. convenience change |
| | | orders; number and |
| | | percentage of |
| | | suppliers impacted; |
| | | number and percentage |
| | | of processes impacted |
| Engineering efficiency - | Rate of failure | percentage of failed |
| reducing failure | on research and | R&D efforts as |
| rates on R&D | development | percentage of current |
| | engineering | R&D budget, as |
| | efforts | percentage of |
| | | historical R&D budget, |
| | | as compared to |
| | | competitors R&D |
| | | budgets (adjusted for |
| | | size & scope of |
| | | competitor) |
| Standard tools | Number of tools | percentage of tools in |
| | used that are | R&D and/or shop floor |
| | standard | that are standard, |
| | | compared to historical |
| | | percentage of, |
| | | compared to |
| | | competitors, compared |
| | | to “expectations” and |
| | | budgets |
| Supplier collaboration | Framework and | Reach, support, age, |
| strategy: Knowledge | tools (e.g. | complexity, |
| capture and exchange | electronic or | sophistication and |
| | paper-based data | cost of current |
| | warehouse | knowledge exchange |
| | systems, etc.) | solution(s) |
| | supporting | |
| | exchange and | |
| | capture of | |
| | operational | |
| | process and | |
| | implementation | |
| | data | |
| Supplier collaboration | Framework and | Reach, support, age, |
| strategy: PLM software | tools (e.g. | complexity, |
| solutions | electronic or | sophistication and |
| | paper-based | cost of current |
| | program | supplier collaboration |
| | lifecycle | tools. |
| | management, | |
| | etc.) supporting | |
| | exchange and | |
| | capture of data | |
| | between and | |
| | amongst | |
| | suppliers and | |
| | Client | |
| Test & QA requirements | Quality | Reach, support, |
| optimization | Assurance | complexity, |
| | testing | sophistication, date |
| | approach, | last reviewed, and |
| | framework, | cost of current Test & |
| | process and | QA requirements |
| | procedures | |

Various exemplary value levers applicable to research and Development (R&D) aspects of costs 340 are listed below in Table 7:

TABLE 7

| Value Levers | Definitions | Potential Measurements |
|---|---|---|
| Engineering change cost | Cost of | number of convenience |
| reduction | “Convenience” or | change orders; as |
| | “Class 2” | percentage of total |
| | engineering | change orders; cost |
| | change orders | per change order for |
| | | convenience change |
| | | orders vs. required |
| | | change orders; number |
| | | and percentage of |
| | | suppliers impacted; |
| | | number and percentage |
| | | of processes impacted |
| Reduce engineering | Number and cost | number of required |
| errors | of engineering | engineering change |
| | errors that | orders; as percentage |
| | require remedy | of total change |
| | | orders; cost per |
| | | change order for |
| | | required change orders |
| | | vs. convenience change |
| | | orders; number and |
| | | percentage of |
| | | suppliers impacted; |
| | | number and percentage |
| | | of processes impacted |
| Engineering efficiency - | Rate of failure | percentage of failed |
| reducing failure | on research and | R&D efforts as |
| rates on R&D | development | percentage of current |
| | engineering | R&D budget, as |
| | efforts | percentage of |
| | | historical R&D budget, |
| | | as compared to |
| | | competitors R&D |
| | | budgets (adjusted for |
| | | size & scope of |
| | | competitor) |
| Standard tools | Number of tools | percentage of tools in |
| | used that are | R&D and/or shop floor |
| | standard | that are standard, |
| | | compared to historical |
| | | percentage of, |
| | | compared to |
| | | competitors, compared |
| | | to “expectations” and |
| | | budgets |
| Supplier collaboration | Framework and | Reach, support, age, |
| strategy: Knowledge | tools (e.g. | complexity, |
| capture and exchange | electronic or | sophistication and |
| | paper-based data | cost of current |
| | warehouse | knowledge exchange |
| | systems, etc.) | solution(s) |
| | supporting | |
| | exchange and | |
| | capture of | |
| | operational | |
| | process and | |
| | implementation | |
| | data | |
| Supplier collaboration | Framework and | Reach, support, age, |
| strategy: PLM software | tools (e.g. | complexity, |
| solutions | electronic or | sophistication and |
| | paper-based | cost of current |
| | program | supplier collaboration |
| | lifecycle | tools. |
| | management, | |
| | etc.) supporting | |
| | exchange and | |
| | capture of data | |
| | between and | |
| | amongst | |
| | suppliers and | |
| | Client | |
| Test & QA requirements | Quality | Reach, support, |
| optimization | Assurance | complexity, |
| | testing | sophistication, date |
| | approach, | last reviewed, and |
| | framework, | cost of current Test & |
| | process and | QA requirements |
| | procedures | |

Various exemplary value levers applicable to Procurement & Materiel costs aspects of costs 340 are listed below in Table 8:

TABLE 8

| | | Potential |
|---|---|---|
| Value Levers | Definitions | Measurements |
| Supplier collaboration | Efficiency and | percentage of |
| | effectiveness of | paper-based |
| | current supplier | processes, |
| | collaboration | turnover of staff |
| | framework, | involved in |
| | activities, and | supplier |
| | resources used | collaboration, |
| Supplier development - | Suppliers managed for | number of staff |
| Joint Investment & | optimized investment | managing |
| Cost Saving (JICS) | of staff and | suppliers, time |
| | financial resources | spent/supplier |
| | | manager managing |
| | | suppliers, |
| | | repetitive work by |
| | | supplier managers |
| Sourcing strategies | Contracts written so | number of staff |
| (Life of Program | annual financial | assigned to |
| Contracts) | negotiations not | procurement; |
| | required with | number of hours or |
| | suppliers | percentage of time |
| | | spent managing |
| | | annual contract |
| | | renegotiation |
| Procurement | Procurement | number of staff |
| outsourcing | outsourcing | assigned to |
| | | procurement; |
| | | number of hours or |
| | | percentage of time |
| | | spent managing |
| | | annual contract |
| | | renegotiation |
| Next Higher Order | Restructure | number of staff |
| Assemblies/Monolithic | purchasing | assigned to |
| structures | management to be | procurement; |
| | Next Higher Order | number of hours or |
| | Assemblies/Monolithic | percentage of time |
| | | spent managing |
| | | annual contract |
| | | renegotiation |
| Drop-off (scrap) | Management of the | Amount of and |
| credit | amount of, and credit | value of raw |
| | for, raw material | material drop-off |
| | drop-off (scrap) for | (per shipset, |
| | valuable raw | program, etc.); |
| | materials | Current management |
| | | or financial |
| | | valuation of raw |
| | | material drop-off |
| Forward buys | Forward buys | number of staff |
| | | assigned to |
| | | procurement; |
| | | number of hours or |
| | | percentage of time |
| | | spent managing |
| | | annual contract |
| | | renegotiation |
| Right-to-buy contracts | Agreements with raw | Number of right- |
| | material suppliers | to-buy contracts |
| | that allow up to | in place, number |
| | certain amounts of | and value of raw |
| | material to be | materials or other |
| | purchased at a pre- | resources at risk |
| | negotiated price for | of price |
| | the life of the | fluctuations |
| | contract | |
| Collaborative buying | Collaborative buying | number of staff |
| | | assigned to |
| | | procurement; |
| | | number of hours or |
| | | percentage of time |
| | | spent managing |
| | | annual contract |
| | | renegotiation |
| Reducing rework costs | Reducing rework costs | number of staff |
| | | assigned to |
| | | procurement; |
| | | number of hours or |
| | | percentage of time |
| | | spent managing |
| | | annual contract |
| | | renegotiation |
| Raw material hedging | Raw material hedging | number of staff |
| strategies | strategies | assigned to |
| | | procurement; |
| | | number of hours or |
| | | percentage of time |
| | | spent managing |
| | | annual contract |
| | | renegotiation |

Various exemplary value levers applicable to manufacturing costs aspects of costs 340 are listed below in Table 9:

TABLE 9
Value Levers

Make vs. buy analysis
(outsourcing)
Flexible labor force
Manufacturing optimization and
tools
Kitting strategies
PLM software solutions (also in
R&D costs),
Maximizing within government
constraints (e.g., SMB,
regulatory Defense Federal
Acquisition Regulations (DFARs),
DoD budget restrictions)
Human performance - Managing
aging workforce
Human performance - Engineering
changes
Human performance - Labor union
optimization

Various exemplary value levers applicable to transport and distribution costs aspects of costs 340 are listed below in Table 10:

TABLE 10

| Value Levers | Definitions | Potential Measurements |
|---|---|---|
| Transportation | Managing | Number of 3PL |
| optimization (e.g. FOB | transportation | providers, type of |
| conversion) | costs thru | transportation costs |
| | Freight-on-Board | currently funded, |
| | conversion and | financial review cycle |
| | potential | of transportation |
| | outsourcing to | costs |
| | 3PL providers | |
| Warehouse optimization | Warehouse and | Number of stockroom |
| (e.g. stockroom | stockroom human | personnel, utilization |
| outsourcing) | and financial | of stockroom |
| | resources | personnel, incentives |
| | engaged in | for stockroom |
| | warehouse | personnel to perform |
| | activities | tasks both inside and |
| | | beyond warehouse |
| Network optimization | | |
| Outsourcing (to third | | |
| party logistics, 3PLs) | | |

Various exemplary value levers applicable to Service and Support aspects of costs 340 are listed below in Table 11:

TABLE 11
Value Levers

Field/Depot service
Call center support
Tech pubs outsourcing (Info
management/security assurance)
Warranty and recall costs
Repair costs
Service parts management
Field/Depot service
Call center support

It should be also appreciated that various other levers related to costs 340 may be used as needed and incorporated into the present invention.

Turning back to FIG. 4, the next step in calculating profits is to calculate capital efficiency 350 in step 420. As depicted in FIG. 3, capital efficiency 350 generally includes working capitol management 360 and fixed assets management 370.

Working Capital gains 360 include, for example, improvement in the management of Inventories, such as vendor managed, consignment, or optimization. Working Capital gains 360 further include reducing Receivables through contractual requirements, collections efforts. Working Capital gains 360 may also include Optimize Payables, such as identifying discount opportunities, payment efficiency, incentives.

Various exemplary value levers applicable to aspects of working capitol 360 are listed below in Table 12:

TABLE 12

| | Definitions as | Some Potential |
|---|---|---|
| Value Levers | needed | Measurements |
| Vendor Managed | Level of vendor | Vendor management of |
| Inventory (VMI) | management and | inventory today |
| | financial risk | |
| | assumed with | |
| | inventory | |
| | management | |
| Inventory optimization | Level of | Inventory weeks of |
| | inventory | supply, inventory |
| | (weeks-on-hand) | value, optimization |
| | relative to | |
| | requirements for | |
| | uninterrupted | |
| | business | |
| Terms maximization | Aggressiveness | Current number of days |
| | of current A/P | A/P outstanding, |
| | terms & | penalties and |
| | conditions | incentives for |
| | | increasing A/P days, |
| | | as compared to |
| | | industry average and |
| | | market leaders |
| Outsourcing A/P | | |
| Terms maximization | | |
| Outsourcing | | |
| Paperless invoicing | | |
| Vendor Managed | Level of vendor | Vendor management of |
| Inventory (VMI) | management and | inventory today |
| | financial risk | |
| | assumed with | |
| | inventory | |
| | management | |
| Inventory optimization | Level of | Inventory weeks of |
| | inventory | supply, inventory |
| | (weeks-on-hand) | value, optimization |
| | relative to | |
| | requirements for | |
| | uninterrupted | |
| | business | |

Calculation of Capitol Efficiency in step 420 further include evaluation of fixed assets 370, including management of facilities and equipment. Various exemplary value levers applicable to fixed asset management 370 are listed below in Table 13:

TABLE 13
Value Levers

Space Optimization - Facilities
consolidation
Space Optimization - Lease versus
buy analysis
Manufacturing tooling
optimization
Test labs
Test equipment
Tools specific to vehicle as a
component of fixed capital (often
on-site at customer)

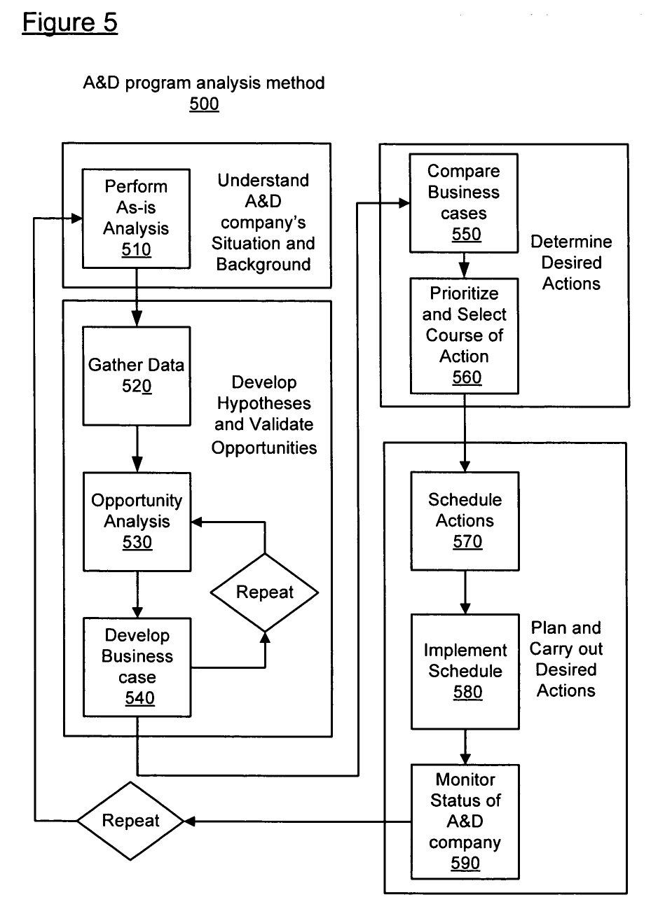

Referring now to FIG. 5, an Aerospace And Defense (A&D) Program Analysis method 500 is now provided. As described below, the A&D Program Analysis method 500 focuses on Profit improvement that is pursued holistically and includes not only a focus on reducing costs or increasing revenues, but also attention to mitigating risks and maximizing benefit realization through appropriate governance models and change management approaches. The A&D Program Analysis method 500 enables rapid opportunity assessment and diagnosis (performed in weeks, not months). The A&D Program Analysis method 500 further enables focus on areas that deliver greatest impact to ROI, profit and A&D company's. Moreover, the A&D Program Analysis method 500 is oriented towards implementation to capture benefits as quickly as possible and offers profit improvement potential by reducing sourcing costs, reducing manufacturing costs, and reducing delivery costs, improving bidding win rates, and improving margin, incentives and contingency on customer deals.

The A&D program analysis method 500 begins with an As-Is analysis in step 510 to evaluate the current condition of the company to diagnose to identify existing and new profit improvement opportunities, develop business case and implementation roadmap. The As-Is analysis step 510 may be performed, as described above in FIG. 4 using the A&D company's current financial data. The As-is analysis may further include examination of the A&D company's business practice to evaluate various value levers, as listed above, to test hypothesis of saving through a series of questions. An examples of an As-Is analysis is depicted below in Table 14:

TABLE 14

| | Hypothesis of | |
|---|---|---|
| Value Lever Area | Savings | Key Question(s) |
| Engineering change | There are a high | Are standard criteria |
| cost reduction | proportion of | are used to determine |
| | “convenience” | “convenience” change |
| | engineering change | orders vs. required |
| | orders that can be | change orders? |
| | avoided | Has the Engineering |
| | | change order process |
| | | been documented to |
| | | distinguish |
| | | “convenience” or |
| | | “Class 2” change |
| | | orders from critical |
| | | change orders? |
| Supplier development - | Suppliers can be | How concentrated is |
| Joint Investment & | better managed by | the supplier base? |
| Cost Saving (JICS) | fewer Client staff & | Could the client gain |
| | improved processes | a significant share |
| | | of cost savings |
| | | through a JICS |
| | | program? |
| Sourcing strategies | Significant client | Are there annual |
| (Life of Program | buyer | renewals in supplier |
| Contracts) | time/activity/money | relationships that |
| | spent today | are consuming |
| | renegotiating annual | significant resources |
| | contracts | today? |
| | Large proportion | Are Material costs |
| | of materiel costs | reviewed/renegotiated |
| | are renegotiated | annually or more |
| | annually (or could | often? |
| | be optimized) | |
| Drop-off (scrap) | Amount and value per | What is the client's |
| credit | unit of drop-off | knowledge about the |
| | (scrap) is | amount and valuation |
| | significant and | of materiel drop-off |
| | unmanaged today | (scrap)? |
| Right-to-buy | Client has limited | Does the client have |
| contracts | or no right-to-buy | Right-to-Buy |
| | contracts in place | contracts in place |
| | to ensure | today? |
| | availability and | |
| | price of raw | |
| | materials | |

Continuing with the A&D program analysis method 500, the next step is to gather data step 520. For each value lever applicable to the A&D program current stage in the program lifecycle 100, several Key Questions may be used as an initial list of information that must be understood for further analysis. When analyzing a value lever module where no Key Questions currently exist, a user may the additional Key Questions. Examples of Key questions are provided in Table 15.

TABLE 15

| Value Lever | |
|---|---|
| Area | Key Question |
| Engineering | How many Engineering changes are there per year? (Can |
| change cost | include Engineering Orders (EOs), Product |
| reduction | Requirements Document (PRD) changes, etc.) |
| | What the percentage of (or How many) of the |
| | Engineering changes are “convenience” or Class 2 per |
| | year? |
| | What the percentage of current “convenience” Class 2 |
| | changes, could a reduction program achieve? (Low-high |
| | estimates) |
| | Are there any government or other requirements that |
| | would preclude changing the current Engineering |
| | Change process? |
| | If known: What is the annual recurring cost of |
| | engineering changes? |
| | If known: What is the nonrecurring cost of |
| | engineering changes? |
| | What is the planned spend with suppliers providing |
| | the top 80the percentage of Materiel? |
| | What is the estimated client share of cost savings |
| | through a JICS program? |
| | What portion of total Materiel spend is with the top |
| | 10 suppliers? |
| | What JICS programs or safeguards are currently |
| | installed in the Program (if any)? |
| | Are there any government or data-sensitivity |
| | requirements that would preclude a JICS program? |
| | How many resources (people) are currently used to |
| | manage supplier relationships |
| | What the percentage of total Materiel costs are |
| | reviewed/renegotiated annually or more often? |
| | Are there any government or data-sensitivity |
| | requirements that would preclude Life of Program |
| | contracts? |
| | What the percentage of Materiel costs could use LOP |
| | purchasing? |
| | How much drop-off (scrap) is generated (per shipset, |
| | per year)? |
| | What is the market value of the drop-off? |
| | How is drop-off managed today? (e.g. is it visible |
| | and credited back to the client, or hidden in SG&A?)0 |
| | Are there any contractual or government issues that |
| | would preclude the client from changing the current |
| | drop-off management system? |
| | What is the Client receiving contracted value of |
| | drop-off? |
| | Does the client have Right-to-Buy contracts in place |
| | today? |
| | Does the client's customers or suppliers have Right- |
| | to-Buy contracts that the client can join? |
| | Are there any government or sensitive requirements |
| | that would preclude Right-to-Buy contracts? |
| | What the percentage of discount could the Client |
| | realize off of average price? |
| | What the percentage of discount could the Client |
| | realize off of current market price? |
| | What is total transportation spend as a percentage of |
| | program cost? |
| | What is the total annual transportation spend? |
| | Does the client have preferred rates with one or more |
| | 3rd party logistics providers (3PLs)? |
| | What percent of transport is with the largest |
| | provider (or 2 or 3, if applicable)? |
| | Are there any government or other customer |
| | restrictions on transportation (e.g. the number |
| | of/location/size of providers, payment terms, etc.) |
| | Do the current transportation contracts have any |
| | clauses or quid-pro-quo requirements that would |
| | preclude changing current transportation options? |
| | What percent is FOB origin? |
| | What percent could be switched to FOB origin? |
| | What percentage savings could be achieved for |
| | switched transport (conservative)? |
| | What percentage savings could be achieved for |
| | switched transport (aggressive)? |
| | How many resources (people) currently are in the |
| | stockroom? |
| | What is the total annual stockroom cost? (By labor, |
| | etc. if known) |
| | What the percentage of total Materiel cost is the |
| | stockroom? |
| | What is the per-resource (person) loaded cost for |
| | stockroom labor? (Or, total cost, if known) |
| | Are there any labor contracts or other restrictions |
| | in place for stockroom personnel (that might preclude |
| | outsourcing)? |
| | Are there any management, contractual, or |
| | governmental restrictions on warehouse labor that |
| | might preclude outsourcing? |
| | What is the 3PL loaded cost per resource (person) for |
| | stockroom labor? |
| | What is the value of current inventory? |
| | What the percentage of Program (or unit) cost is |
| | inventory? |
| | Are there any internal client differences in |
| | inventory procurement (e.g. 2 procurement groups at |
| | different cost rates) that might make VMI more or |
| | less expensive? |
| | Are there any management, contractual, or |
| | governmental restrictions on inventory that might |
| | preclude VMI? |
| | What is the carrying cost (per month or other period) |
| | of inventory? |
| | What is the average Program inventory value? |
| | What is the average Period of Supply (POS)? |
| | What are the risks of stockouts? (Answer in |
| | financial or qualitative terms - which will then need |
| | translation to financial terms) |
| | What is the value of one week's supply? |
| | What are the inventory carrying costs? (Answer in the |
| | percentage of total Program costs or $ if known) |
| Terms | How many days are A/P standard terms? |
| maximization | What is the value of Material spend? |
| Outsourcing | What is the Program daily cash flow? |
| A/P 0 | Are there any management, contractual, or |
| Terms | governmental restrictions on A/P terms that might |
| maximization | preclude changing A/P Terms? |
| Outsourcing | How many days A/P could improvement |
| | achieve? (Include at least high/low estimates) |

Continuing with the A&D program analysis method 500, the next step is to perform an opportunities analysis step 530 of the A&D business using the as-is analysis from step 510 and the gathered data results from step 520. The opportunities analysis step 530 determines the potential net benefits from possible actions (i.e., predicted benefits minus expected costs). The opportunities analysis results may be used as a baseline where value levers have been analyzed before. The assumptions for the opportunities analysis may be pre-defined (i.e., using a stored assumption set) or may be defined dynamically using user input or from other information/standards sources. There may also be a high level set of assumptions (e.g. annual program cost) that are used in multiple analysis modules. When evaluating a value lever having no prior examples, a user may add analysis framework to the list.

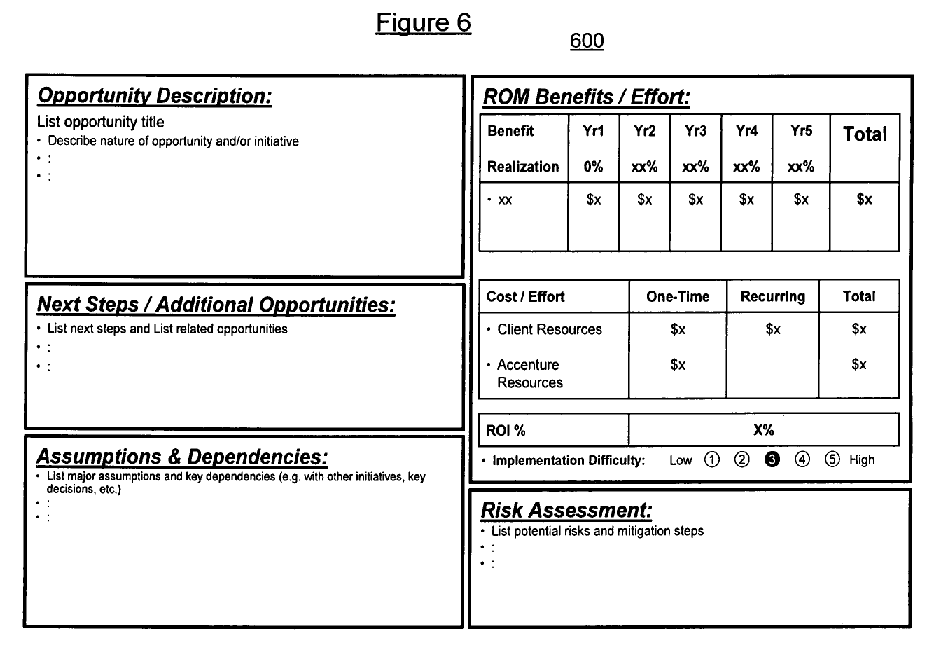

Thus, it can be seen that in the initial stages of A&D program analysis method 500 between step 510 and 530, a user develops hypothesis of high priority opportunity areas; gathers data and conduct interviews/work sessions; perform analyses and estimate benefits for each opportunity area; estimate level of effort (resources, duration) for each opportunity area; and Highlight key assumptions. The output from steps 510-530 may include a list of profit improvement opportunity areas and preliminary benefit and cost estimates with assumptions. Each of the opportunities may be summarized in an opportunity summary 600 as depicted in FIG. 6. The Opportunity Overview 600 is typically a short, one-page summary of the improvement opportunity including the description, key assumptions, and rough order of magnitude (ROM) benefits and costs. This template is effective for communicating essential elements of an improvement opportunity area (e.g., for executive summary presentations).

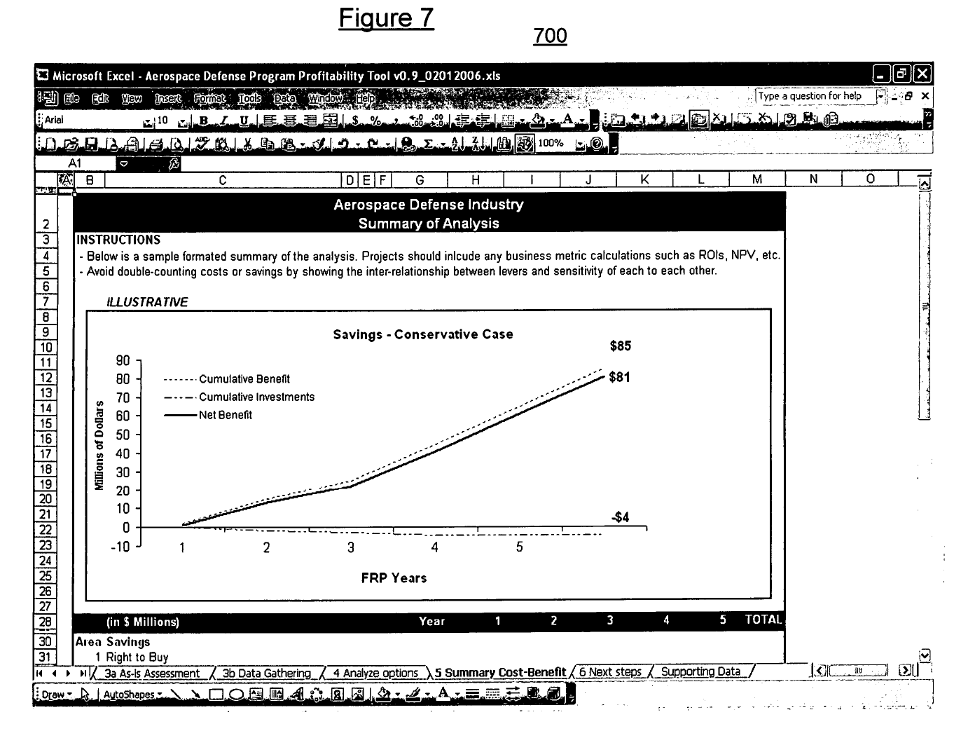

Continuing with the A&D program analysis method 500, the next step is to create a business case in step 540 summarizing the expected increased profits according to the opportunity analysis step 530. In addition to the value creation calculations described in method 400, the business case developed in step 540 may additionally include other known business metric calculations such as return on Investment (ROI), Net Present Value (NPV), etc. An exemplary business case report 700 is depicted in FIG. 7.

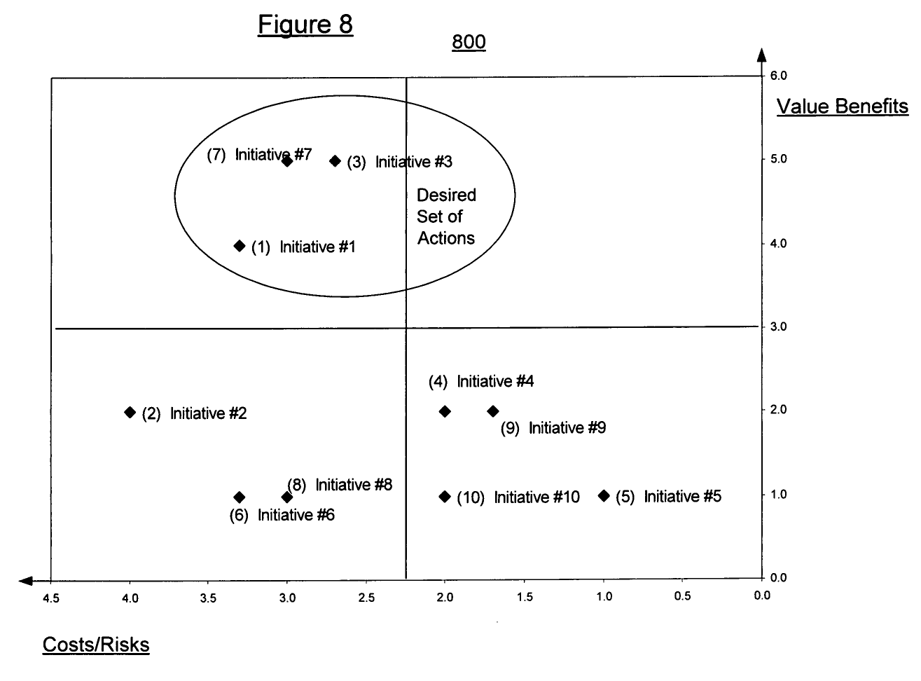

The business case from each of the prospective actions performed in step 540 may be compared in step 550. For example, the business cases may be combined for direct comparison between the various proposed actions. For example, each of the proposed courses of actions may be depicted in an Aerospace and Defense Program Profitability Prioritization Matrix, and an exemplary Matrix 800 (with entirely hypothetical values) as depicted in FIG. 8. The Prioritization Matrix 800 may depict the various proposed actions according their predicted value results and their expected costs. In this way, a user may examine and quickly determine preferred course of actions (i.e., those having relatively low cost and high gains).

Thus, the development of the business case in step 540 includes the steps of finalizing a high level business case model, developing prioritization criteria, identifying key dependencies, identifying risks and develop preliminary mitigation steps, and prioritizing profit improvement initiatives. The output from step 540 includes creation of a high level business case model, prioritized of initiatives, and a risk assessment.

After the comparison of step 550, a course of action may be selected in step 560. The user selects various proposals and can then separately test the combination of actions to ensure that the desired results should still materialize since various actions may be counterproductive to the same lever or may somehow be mutual exclusive.

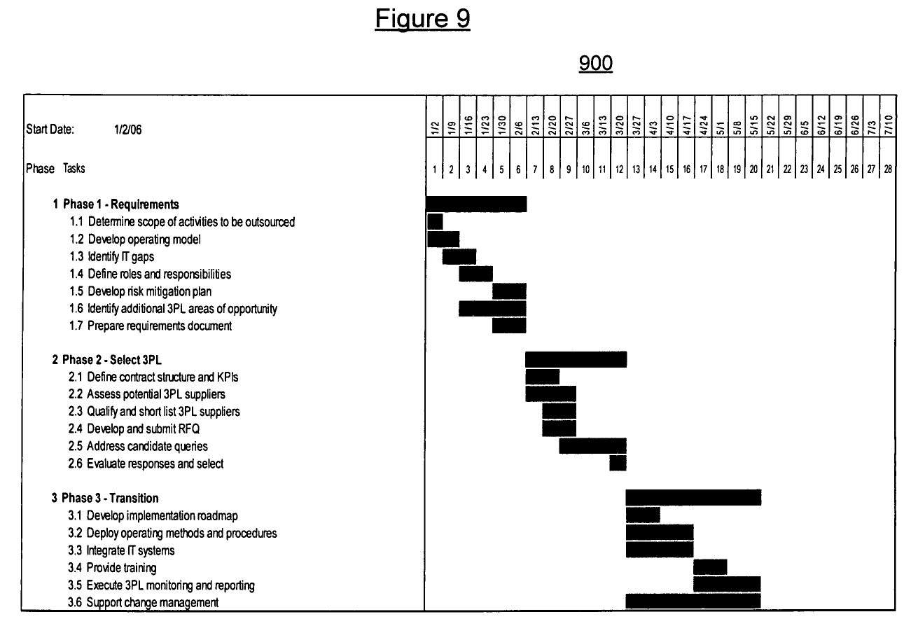

Following selection of course of action in step 560, the schedule of actions may be formed in step 570. For example a Gantt chart 900 as depicted in FIG. 9 may be used to time the performance of the various actions.

The Gantt chart 900 is a popular type of bar chart that aims to show the timing of tasks or activities as they occur over time. Although the Gantt chart may indicate the relationships between activities as both timing and interdependencies between tasks can be identified. In project management, a Gantt chart can show when the project terminal elements start and finish, summary elements or terminal element dependencies. A terminal element is defined as the smallest task tracked as part of the project effort. Since the initial introduction of Gantt charts, they have become an industry standard as a key project management tool for representing the phases, tasks and activities that are scheduled as part of a project work breakdown structure or timeline of activities. Other methods exist to represent the tasks within a project, such as a network diagram or PERT chart, but these is used more to show the relationship between tasks rather than focusing on the timeline.

In step 580, the action items are carried out according schedule depicted the Gantt chart formed in step 570.

Thus, step 550-580 entail developing an implementation roadmap and workplans for each initiative, briefing findings and recommendations, and identifying initiatives to pursue immediately and determine next steps. For example, a user may implement a roadmap and workplan. An opportunity Workplan template summarizes the timing, key tasks, deliverables and resources needed for each opportunity area. This template helps organize workplan elements for each improvement opportunity area.

Then, in step 590, the actual results from the course of action are monitored and measured. Implement performance measurements and metrics are used to ensure profit improvements and sustaining of capabilities. If desired, the company can be re-evaluated using, using the post implementation status as a new As-is point in order to determine new and follow-up courses of action.

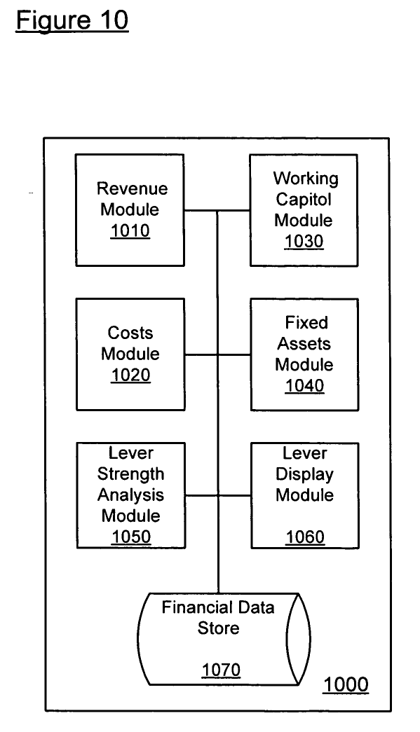

Turning now to FIG. 10, an A&D project evaluation tool 1000 implemented in embodiments of the present invention is now described. The A&D project evaluation tool 1000 may be a software-driven application including modules that automatically perform each of the steps of a value calculation method 400, described above. Specifically, the A&D project evaluation tool 1000 includes modules 1010, 1020, 1030, and 1040 for calculating, respectively, the revenue effects, costs effects, working capitol effects, and fixed assets effects. Complementing these modules 1010 to 1040 is a financial data store 1070 corresponding to a financial data repository containing collected financial data relevant to the A&D organization.

Continuing with FIG. 10, the technology expenditure evaluation tool 1000 optional further comprises a lever strength analysis module 1050. The lever strength analysis module 1050 analyzes the various levers, as described above to evaluate accounting constituents of the value, as determined through the A&D value calculation method 400. It should be appreciated that virtually any known financial and project performance measure may be used as a lever to analyze an changes in the organization's value to A&D company'ss and the results of changes from the lever caused by proposed change in the A&D project.

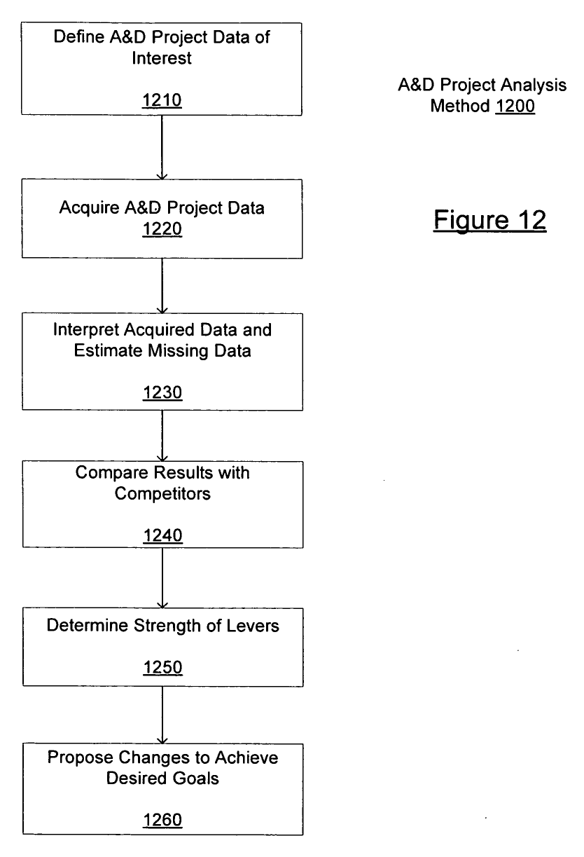

The lever strength analysis module 1050 works, as described in greater detail below in the A&D Project evaluation method 1200 in FIG. 12 and the related text, by analyzing the effects of changing one or more of the various project and accounting measures (levers). The lever strength analysis module 1050 may calculate the changes in the company's value 310 from changes in each of the levers. This may help identify areas in which an organization can change to improve return to values and areas where changes would have little changes in value. For example, an organization may already have low labor costs, and projects changes causing reduction in labor costs may have little benefit to the company's value. In the same way, the lever strength analysis module 1050 may predict the A&D company's return changes from the multiple financial changes caused by a complex business decision, such as a investment in new production equipment that increases overall productivity while decreasing labor costs while also changing project performance measures such as improved overall quality, increased production speed and capacity, and changes in maintenance costs.

Changes in the lever values may be programmed by a user or may be automatically determined by the A&D project value tool 1000 by other known applications for predicting the effects of business and technology changes. For example, various known return on investments (ROI) tools predict economic number changes to an organization resulting from various technology expenditures, and these types of know application may be used to predict changes to the levers. Alternatively, the changes to the levers caused by various business activities may be studied and accessed, as described in co-owned pending U.S. application Ser. No. 10/903,488 filed on Aug. 2, 2004 the subject matter of which is incorporated by reference in full.

The results of the lever strength analysis module 1050 may be stored in the Financial Data store 1070, and a lever strength graphical display module 1060 may then graphically display the results in any form or format. The graphical display may also compare the relative lever strength between different related companies. As described in greater detail below, the present invention thereby allows a comparison of performance in specific areas as measured by their effects on A&D value. For example, a value changes from the same action by different A&D companies may be compared. A&D companies that are very sensitive to increased research and development likely under invest whereas companies whose A&D company's return is insensitive to increase research and development likely already invest sufficiently in R&D or otherwise suffer from other limitations that limit the benefits of additional R&D.

An a preferred embodiment, the A&D project evaluation tool 1000 is a methodology guide and tool set that are designed to help teams quickly and systematically: to 1) Assess the current state of an A&D client's program profitability; 2) Identify, prioritize and recommend profit improvement opportunities, and 3) Develop a high level implementation roadmap and detailed workplans. In one embodiment, the A&D project evaluation tool 1000 is an Excel®-based tool contains a set of templates that can be used to perform the analysis of opportunity areas and includes:
a. Major value levers associated with profit improvement for A&D companies
b. List of key questions and data request items to perform the analysis
c. Example of an improvement opportunity analyses for raw materials, supplier collaboration, transportation and distribution, and engineering change
d. Example of a high level business case model and opportunity prioritization framework
5) Additional templates for implementation planning (e.g., GANTT chart, 90 day workplan)

In this way, the A&D project evaluation tool 1000 provides an evaluation framework and quantitative analysis examples for Aerospace Defense Industry client program profitability, both opportunities and risks.

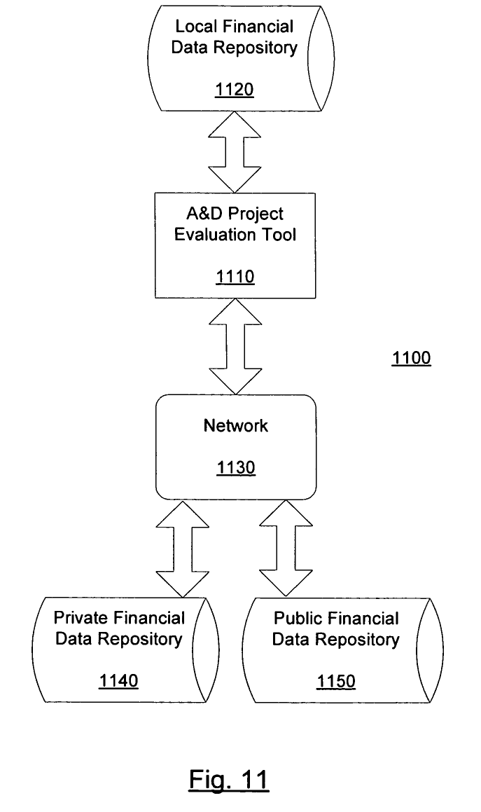

Referring now to FIG. 11, an A&D value network 1100 having an A&D value tool 1110, similar to the configuration in described above in FIG. 10, is now described. The A&D value tool 1110 may be a dedicated application, coded using known techniques or programming language (such as VisualBasic™), to implement the methods and processes described herein. The A&D value tool 1110 may be functionally connected to a local financial data repository 1120, such as a known data storage device or data storage network, for storing financial data collected over a network 1130 from public financial data repositories 1150.

For example, the public financial data repositories 1150 may include to OneSource® at www.onesource.com to acquire Analyst reports, Comparables, Industry reports, Recent news, Financials-SEC docs, Corporate Affiliations, Executives-with bios, and data on Private companies. Similarly, the A&D project tool 1110 may connect to the Electronic Data Gathering, Analysis and Retrieval (EDGAR) database at the United States Securities and Exchange Committee (SEC). For more information on EDGAR, please refer to http://www.sec.gov/edgar.shtml. To assist the public in valuing a company and thus valuing that company's stock, publicly traded companies may be legally required to provide various accounting and financial disclosures. For instance, most publicly traded companies in the United States are required to submit financial disclosure data to the SEC, which publishes this information online to the public. Specifically, the SEC requires all publicly traded companies (except certain foreign companies and companies with less than $10 million in assets and fewer than 500 A&D company'ss) to file registration statements, periodic reports, and other forms electronically through the EDGAR database.

The A&D project value tool 1110 may further connect with a private financial data repository 1140 that contains information not generally available to the general public. For example, an organization may implement the A&D company's value network 1100 to assess its own performance and to predict future A&D company's value.

In operation, the pre-collection of relevant financial data in the local financial data repository 1120 offers significant performance advantages. In exchange for the computation and time cost associated with the collection and local storage of the financial data, the A&D project value network 1100 may operate much more rapidly using the financial data contained in the local financial data repository 1120 since the data collection is a relatively time-consuming process. This advantage is particularly present where the A&D project value tool is used several times on the same financial data. For example, the A&D project value tool 1110 may be used to analyze several different competing organizations in the same industry. Similarly, as described in greater detail below, the financial data in the local financial data repository 1120 may be adjusted to reflect various changes, actual or proposed, and the A&D project value tool 1110 may be used to analyze the changes in the A&D company's value resulting from these changes.

Referring back to FIGS. 2A-2B, A&D project value tool 1000 in accordance with an preferred embodiment of the present invention is depicted. Specifically, the A&D project value tool 1000 is an Excel® based application containing several tabs 201-209 that guide the user through the A&D project value process 500.

The Program Lifecycle framework tab 201 is an entry-point for developing hypotheses of improvement opportunities. The Program Lifecycle framework tab 201 contains definitions of each phase of a program lifecycle. Optionally, depending on a program's lifecycle stage, greater emphasis will exist in different opportunity areas. As described above, mature programs may tend to focus on improving efficiencies (e.g., materiel and manufacturing cost reduction). Newer programs may tend to focus on improving effectiveness (e.g., win-strategies that enhance revenues).

A Value Tree Framework tab 202 provides an overview, description, and potential measures of profitability value levers and can be used to further identify improvement opportunity areas. The Value Tree Framework tab 202 contains definitions and example measures for key profitability value levers. The Value Tree Framework tab 202 is a more detailed view of elements that impact revenues, costs and capital, ultimately affecting A&D company's value.

The Current Maturity Assessment, or As-is, tab 203 provides a sample set of key questions to determine if improvement opportunities may exist. Each value lever has key questions to gauge current capabilities and determine if an improvement opportunity exists.

The gather data tab 204 contains more detailed validation and data gathering questions for each value lever. Specifically, each Value Lever has more detailed data gathering and validity questions to further investigate potential opportunity areas.

The analyze opportunities tab 205 contains example analysis to quantify the benefits of opportunity areas from a recent program profitability assessment project. For example, The analyze opportunities tab 205 may contain examples of rough order of magnitude quantitative benefits associated with select opportunity areas

Turning now to FIG. 2B that provides an alternate depiction of the A&D project evaluation tool 1000′, an estimate resources tab 206 contains a template for quantifying costs of client and other project resources. The estimate resources tab 206 contains a resource cost estimation template

An Opportunity Overview tab 207 is a one-page summary of the improvement opportunity including the description, key assumptions, and rough order of magnitude (ROM) benefits and costs. The Opportunity Overview tab 207 communicates essential elements of an improvement opportunity area (e.g., for executive summary presentations), and prioritizes opportunities based on a set of criteria including benefits, costs and risks. In this way, a user may use the A&D project tool 1000 to finalize a high level business case model, along with gathering benefits and costs for each opportunity area into a consolidated model as well as determining key business case metrics to ROI, NPV, IRR, payback period, etc. Moreover, the user can then prioritize opportunities and initiatives and determine prioritization criteria and framework (e.g. value versus effort 2×2) by asking the A&D project tool 1000 to plot opportunity areas on the framework and to assess risks and develop preliminary mitigation steps.

In this way, the user may define the business case for each opportunity area (benefits, costs, risks), the business case for all opportunity areas, the prioritization of the opportunity areas relative to each other, and the risks and mitigation steps.

Continuing with FIG. 2B, the prioritize opportunities tab 208 may provide an example summary of the costs and benefits associated with changes to the value levers reviewed. For example, the prioritize opportunities tab 208 may provide an example business case summary of benefits and costs by opportunity area. In addition to cumulative benefits, the business case summary contains other key metrics such as ROI percentage of NPV (net present value), IRR (Internal rate of return, and Payback Period

A separate Prioritization Tool at tab 208 may be used to prioritize opportunity areas against a defined criteria (e.g., value versus effort). The Prioritization Tool contains an example framework for prioritizing each opportunity area according to value versus effort, where value (vertical axis) is based on total cumulative savings or benefits and effort (horizontal axis) is based on costs, difficulty and risks

Tab 209 contains a GANTT chart template that can be used to provide additional details of tasks and duration. This template is used in conjunction with the workplan and resource estimator to determine implementation requirements

Turning now to FIG. 12, the A&D project evaluation method 1200 may be used to analyze an A&D project and the effects of various actions that may change various levers used evaluating the performance of the A&D project. The value of this functionality arises because an A&D company's value is often generally known (such as the stock price and dividends), but the constituting factors (the levers) impacting the value and the relative importance of these factors is often ambiguous at best. Accordingly, other embodiments or the present invention provide an automated tool and method for analyzing the causes for value and for assessing proposed actions according to their probable impact on value. Often, it is particularly difficult to evaluate business actions because the actions have complex, conflicting results that are difficult to assess as a whole. For example, in the situation of acquiring new equipment, the equipment typically has upfront purchase costs as well as continued maintenance costs that must be counter-balanced against the proposed benefits, such as increased worker productivity. An A&D equipment upgrade may further improve the quality of goods and services, thereby increase sales volumes and prices. While traditional policy analysis tools address attempt to provide a numerical analysis addressing these types of the economic factors, the traditional analysis tools were wildly inaccurate in predicting the end result of particular importance—the overall improvement to an organization's value.

Referring back now to FIG. 12, the A&D project evaluation method 1200 begins with defining and acquiring A&D project data of interest, respectively, in steps 1210 and 1220. As previously above in the discussion of the A&D Value method 400, the definition of the A&D data of interest in step 1210 generally studying and gathering data on the organization of interest. The information defined in step 1210 generally includes accounting data as needed to perform the various steps and calculations involved in the value analysis method 400 or other similar value calculation methods. For many publicly traded organizations, the various value measures are already available in the form of stock value changes and dividends and bond payments. The selected materials are then obtained in step 1220 using known methods and technology and may be stored in a data storage device, such as the financial data store 1070.

Continuing with FIG. 12, the acquired A&D data is then interpreted in step 1230 using the value analysis method 400 or other known data process for addressing the factors impacting an A&D company's value. As suggested above, the value may already be known and the value analysis methods may be used in reverse to estimate missing or unavailable data. In optional step 1240, a similar process (mirroring steps 1210-1230) may be used for competitors so that a company's value and constituting factors may be compared to its competitors. Step 1240 generally comprises manually selecting organizations or otherwise manually selecting a relevant industry group and automatically analyzing those companies.

Continuing with FIG. 12, the strength of various levers may be analyzed through various known sensitivity analysis techniques that slightly change one or more data inputs and then determining the results of the changes. For example, various financial data inputs may be individually manipulated by predefined adjustment amounts and adjustment ranges to determine the results of these changes to value 310. It is typically found, for example, that relatively mature companies are rather insensitive to increased infrastructure expenditures since these companies generally have made large previous infrastructure expenditures. As discussed above, a lever may be any type of known, definable cause impacting A&D company's value 310, such as the various values defined above in connection with the value analysis method 400. In step 1250, the strength of a lever may likewise be determined for competitors, and the relative lever strengths may be compared. Overall, this analysis allows a user to determine the relative ability of any single or combination of factors to improve value, as well as to compare an A&D company to its competitors.

Once the relative lever strengths are determined in step 1250 (i.e., determine the ability of various changes to improve vale), these results may be used in step 1260 to assess proposed changes or to propose actions to achieve a desired change in value 310. To propose changes, a strong lever is identified, and actions leading to changes in this lever are forwarded. In a similar way, proposed actions may be assessed according to their predicted changes to one or more levers. As described above, there are various known methods and tools to predict the effects from a business action, but these tools do not predict changes to value changes from these changes.

In step 1260, the present invention may use the results from these tools to assess proposed changes according to their predicted effect on the A&D company's value. Typically, the financial data collected in step 1220 is adjusted according to the predicted changes from adjustments from the various levers, and the value 310 is recalculated in step 1230. Alternatively, the levers changed from a business action may be identified by the known applications, and the strength of these levers may be evaluated using the results determined from lever strength analysis in step 1250.

In this way, it can be seen the value analysis method 400 may be applied as suggested in the A&D value lever analysis method 1200 to analyze an organization's areas of needs (i.e., areas corresponding to strong levers that may potentially produce improvements in value). Similarly, the A&D company's value lever analysis method 1200 may be used to evaluate proposed actions according to the effects of these actions on the various levers and the relative strengths of the these levers.

### CONCLUSION

The foregoing description of the preferred embodiments of the invention has been presented for the purposes of illustration and description. It is not intended to be exhaustive or to limit the invention to the precise form disclosed. Many modifications and variations are possible in light of the above teaching. For instance, the method of the present invention may be modified as needed to incorporate new communication networks and protocols as they are developed. It is intended that the scope of the invention be limited not by this detailed description, but rather by the claims appended hereto. The above specification, examples and data provide a complete description of the manufacture and use of the composition of the invention. Since many embodiments of the invention can be made without departing from the spirit and scope of the invention, the invention resides in the claims hereinafter appended.

1. An automated method for evaluating proposed changes to an Aerospace and Defense (A&D) project, the method comprising steps of:
collecting A&D project data;
performing an analysis of the A&D project using the collected data;
a step for calculating value effects of a first proposed change in the A&D project using the collected A&D project data and the analysis of the A&D project;
calculating costs of the first proposed change in the A&D project; and
comparing the calculated value effects and calculated costs of the first proposed change.

2. The method of claim 1 further comprising a step of producing a business case report summarizing the value effects of the first proposed changes.

3. The method of claim 1 further comprising a step of graphically displaying the value effects of the first proposed changes.

4. The method of claim 1 further comprising steps of:
implementing the first proposed action;
monitoring the A&D project to collect additional project data;
reanalyzing the A&D project using the collected A&D project data and the additional A&D project data; and
A step for recalculating the value effects of the first proposed using the reanalysis of the A&D project;
recalculating costs of the first proposed change; and
comparing the recalculated value effects and calculated costs of the first proposed change.

5. The method of claim 1 further comprising a step of
a step for calculating value effects of a second proposed change in the A&D project using the collected A&D project data and the analysis of the A&D project;
calculating costs of the second change in the A&D project; and
comparing the calculated value effects and calculated costs of the first proposed change to the calculated value effects and calculated costs of the second proposed change.

6. The method of claim 5 further comprising a step of graphically displaying the value effects and in comparison to the costs of each a plurality of the proposed changes.

7. The method of claim 6 further comprising a step of automatically identifying a preferred subset of the plurality of proposed changes, wherein said preferred subset of proposed changes have relatively high value effects and low costs.

8. The method of claim 7 further comprising a step of scheduling implementation of said plurality of proposed changes, wherein said scheduling prioritizes said preferred subset of proposed changes.

9. The method of claim 1, wherein the step for calculating the value effects comprises a step for calculating profit effects and a step for calculating capitol efficiency effects.

10. The method of claim 9 wherein the step for calculating the profits effects comprising a step for calculating revenue effects and a step for calculating costs effects.

11. The method of claims 9 wherein the step for calculating the capitol efficiency effects comprising a step for calculating working capitol effects and a step for calculating fixed assets effects.

12. The method of claim 1 wherein the step for calculating the value effects comprises:
defining one or more value levers, and
calculating effects of first proposed change on each of the value levers at each stage of an A&D project lifecycle, wherein said A&D project lifecycle comprising a research and development phase, a proposal phase, a prototype phase, a low rate initial production phase, full rate production phase, support and service phase and an end-of-life phase.

13. An automatic method for analyzing an Aerospace and Defense (A&D) project, the method comprising steps of:
collecting data on the A&D project;
a step for calculating a value of the A&D project using the collected data;
defining one or more value levers, wherein each of the levers has an effect on the value of the A&D project;
defining a measure for each of the value levers;
modifying each of the defined value levers measures by a pre-specified amount;
for each of value levers, a step for calculating a gain in the value of the A&D project from the modification;
for each of the value levers, calculating a cost to the A&D project from the modification;
for each of the value levers, comparing the value gain and the cost for the modification; and
identifying a subset of the value levers, wherein said modification of each of the value levers in said subset has a relatively large value gain and a relatively low cost.

14. The method of claim 13 further comprising a step of, for each of the value levers in the subset, identifying one or more actions that achieve said modification to the associated measure.

15. The method of claim 13 further comprising steps of:
repeatedly modifying each of the value levers measures in the subset by said pre-specified amount;
for each of the value levers in the subset, a step for recalculating the gain in the value of the A&D project from each of the modifications;
for each of the value levers in the subset, calculating a cost to the A&D project from each of the modifications;
for each of the value levers in the subset, comparing the value gain and the cost for each of the modifications; and
for each of the value levers in the subset, identifying a preferred number modifications to achieve a desired value gain and a desired cost, wherein the step of identifying one or more actions further comprises, for each of the value levers in the subset, identifying said actions that achieve said preferred number of modifications.

16. An Aerospace and Defense (A&D) project analysis system comprising:
a data store containing A&D project data;
an A&D project analysis tool to calculate an original value of the A&D project using the A&D project data, wherein said A&D project analysis tool comprising a revenue module to calculate revenue value, a cost module to calculate cost value, a working capital module to calculate working capital value, and a fixed assets module to calculate fixed assets value.

17. The A&D project analysis system of claim 16 further comprising a lever analysis module, wherein said lever analysis module determines and forwards modified A&D project data to the data store to reflect a change in a value lever, wherein the A&D project analysis tool accesses and uses the modified A&D project data to calculate a modified value of the A&D project, and wherein said lever analysis module compares the original value and modified value of the A&D project.

18. The A&D project analysis system of claim 17, wherein the lever analysis determines and forwards a plurality of modified A&D project data sets to the data store, each of the modified A&D project data sets corresponding to a change in each of a plurality of value levers, wherein the A&D project analysis tool accesses and uses each of the modified A&D project data sets to calculate a plurality of modified values of the A&D project, and wherein said lever analysis module compares each of the plurality of modified values of the A&D project.

19. The A&D project analysis system of claim 18 further comprising a lever display module to graphically display said modified values of the A&D project, each of said modified values corresponding to a change in each of a plurality of value levers.

20. The A&D project analysis system of claim 16 further comprising means for acquiring said A&D project data, wherein said project data acquiring means collects A&D project data from local and distant data repositories.
